(19) United States
(12) Patent Application Publication
(10) Pub. No.: US 2024/0200405 A1
(43) Pub. Date: Jun. 20, 2024

(54) ROLLING SHUTTER CAM LOCK SLAT

(71) Applicant: Qualitas Manufacturing Incorporated, Itasca, IL (US)

(72) Inventor: Craig N. Zarbeck, Stevensville, MI (US)

(21) Appl. No.: 18/533,408

(22) Filed: Dec. 8, 2023

Related U.S. Application Data
(60) Provisional application No. 63/433,212, filed on Dec. 16, 2022.

(51) Int. Cl. E06B 9/86

(52) U.S. Cl. CPC E06B 9/86; E06B 2009/804

(57) ABSTRACT

A lock slat for a rolling shutter comprises a housing having opposite first and second sides. A housing channel is formed between the first and second sides. A cam is coupled to the housing, and is moveable between a locked position to secure the rolling shutter, and an unlocked position. A cam slat is slidably received in the housing channel, and is coupled to the cam. The movement of the cam slat in the housing channel moves the cam between the locked and unlocked positions.

### CROSS REFERENCE TO RELATED APPLICATIONS

This application claims the benefit of U.S. Provisional Application No. 63/433,212, filed Dec. 16, 2022, which is hereby incorporated by reference herein in its entirety.

### BACKGROUND OF THE INVENTION

The present invention relates to rolling shutters and, in particular, to a lock slat for a rolling shutter that prevents the shutter from being raised from the closed position.

Rolling shutters are commonly used in commercial, retail and residential applications as doors or to cover windows or other openings in a structure. The rolling shutter is made of a series of slats that are linked together to form an articulated curtain. The slats typically span the width of the opening, and are formed with an upper edge having a hook-shaped engaging track, and a lower edge having a receiving track that forms a pocket for receiving the engaging track of another slat. The slats are linked by the slidable engagement of the engaging track of a first slat in the receiving track of a second slat, to form a loosely articulated hinge between the slats. In an open position, the rolling shutter is retracted and raised away from the opening by winding the slats about a spindle positioned at the top of the opening. In the closed position, the slats are unwound from the spindle and lowered or extended toward the bottom of the opening. An example of a shutter slat is described in U.S. Pat. No. 9,074,411 to Miller et al., which is incorporated herein by reference.

The opening of the structure commonly includes a frame comprising guide tracks positioned at the sides of the opening. The guide tracks receive the ends of the slats, to align and hold the slats in position to cover the opening. The rolling shutter may incorporate an end retention system to retain the ends of the slats in the guide tracks. In conventional end retention systems, the ends of the slats are formed with a receptacle for receiving an end retention device, such as a fastener with a washer that is retained within a channel of the guide track. Examples of end retention systems are described in U.S. Pat. Nos. 8,616,261 and 8,925,617 to Miller, which are incorporated herein by reference.

The rolling shutter may include a base slat, which is positioned at the end of the series of linked slats to contact the bottom of the opening when the shutter is in the closed position. The base slat may include a seal and/or may be shaped to conform to the bottom of the opening to prevent gaps that would allow intrusion, such as the insertion of a pry tool. The base slat may also include a locking device for securing the rolling shutter in the closed position and prevent it from being raised from the bottom of the opening.

Rolling shutters locking mechanisms commonly comprise a keyed dead bolt or hook bolt. These locking mechanisms are often retrofit on the rolling shutter, and require the operator to take action to secure the rolling shutter. It would be desirable to have a locking mechanism that is integral to the rolling shutter and that secures the rolling shutter automatically, without the need for action by the operator.

### SUMMARY OF THE INVENTION

An embodiment of a lock slat for a rolling shutter comprises a housing, a cam, and a cam slat. The housing has opposite first and second sides, a housing channel formed between the first and second sides, and a housing width defined between the first and second sides. The cam is coupled to the housing, and is moveable between a locked position where the cam projects beyond the housing width, and an unlocked position where the cam does not project beyond the housing width. The cam slat is slidably received in the housing channel, and is coupled to the cam. Wherein the movement of the cam slat in the housing channel moves the cam between the locked and unlocked positions.

An embodiment of a locking system for a rolling shutter comprises a guide track and a lock slat. The guide track includes a guide channel. The lock slat comprises a housing, a cam slat, and a first cam. The housing includes a housing channel, and has an end positioned at the guide channel. The cam slat is slidably received in the housing channel. The first cam is coupled to the housing and the cam slat, and is moveable between a locked position where the first cam engages the guide track, and an unlocked position where the first cam does not engage the guide track. Wherein the movement of the cam slat in the housing channel moves the cam between the locked and unlocked positions.

An embodiment of a rolling shutter system comprises a guide track, a plurality of shutter slats, and a lock slat. The guide track includes a guide channel. Each shutter slat has an engaging track and a receiving track, the receiving track having a pocket for receiving the engaging track of another shutter slat. The lock slat comprises a housing, a cam, and a cam slat. The housing includes a housing channel, and has an end positioned at the guide channel, and an edge having an engaging track received in a receiving track of a shutter slat. The cam is coupled to the housing, and is moveable between a locked position where the cam engages the guide track, and an unlocked position where the cam does not engage the guide track. The cam slat is slidably received in the housing channel and is coupled to the cam. Wherein the movement of the cam slat in the housing channel moves the cam between the unlocked and locked positions.

### BRIEF DESCRIPTION OF THE DRAWINGS

FIG. 1 is a front elevation view of an embodiment of a lock slat in an unlocked position.

FIG. 2 is a side section view of the lock slat of FIG. 1.

FIG. 3 is a partial orthographic view of the lock slat of FIG. 1 installed in a rolling shutter system.

FIG. 4 is a detail view of the lock slat of FIG. 3.

FIG. 5 is a partial front elevation view of the lock slat of FIG. 3.

FIG. 6 is a side section view of the lock slat of FIG. 5.

FIG. 7 is a detail view of the lock slat of FIG. 5.

FIG. 8 is a side section view of the lock slat of FIG. 7.

FIG. 9 is a front elevation view of the lock slat of FIG. 1 in a locked position.

FIG. 10 is a side section view of the lock slat of FIG. 9.

FIG. 11 is a partial orthographic view of the lock slat of FIG. 10 installed in a rolling shutter system.

FIG. 12 is a detail view of the lock slat of FIG. 11.

FIG. 13 is a partial front elevation view of the lock slat of FIG. 9.

FIG. 14 is a side section view of the lock slat of FIG. 13.

FIG. 15 is a detail view of the lock slat of FIG. 14.

FIG. 16 is a side section view of the lock slat of FIG. 15.

FIG. 17 is a partial orthographic view of a rolling shutter with an alternative embodiment of a lock slat in a locked position.

FIG. 18 is a side elevation view of the rolling shutter and lock slat of FIG. 17.

### DETAILED DESCRIPTION OF THE INVENTION

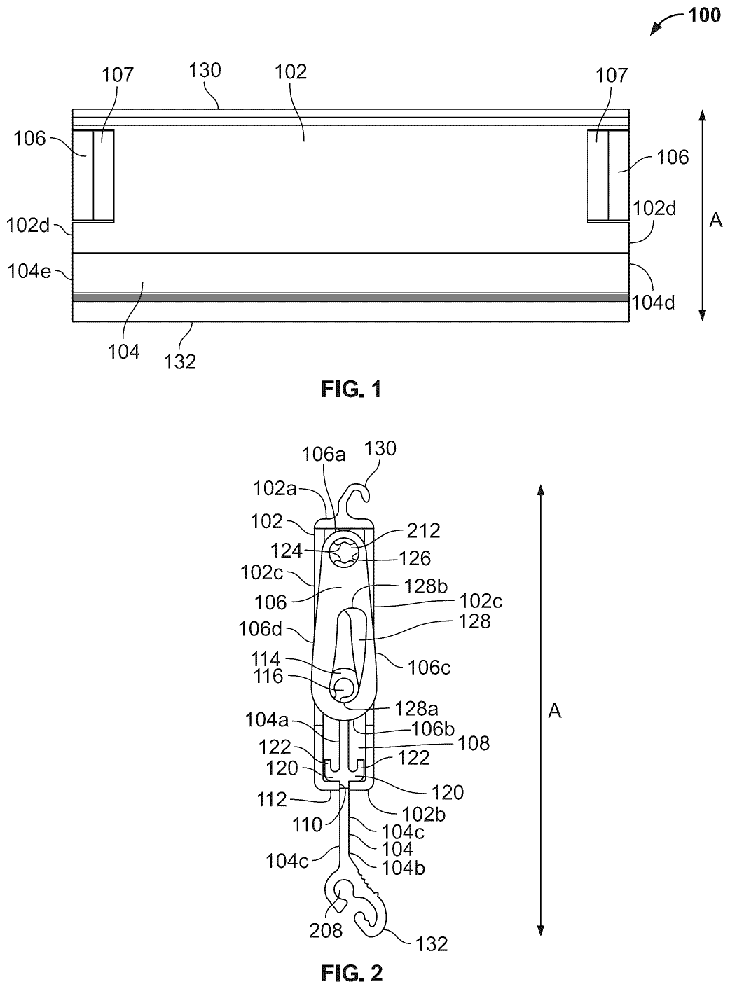

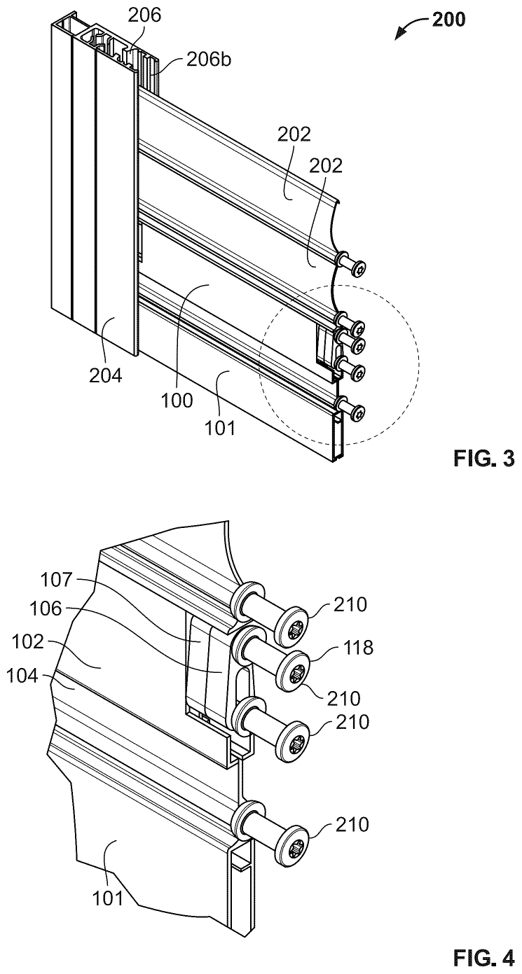

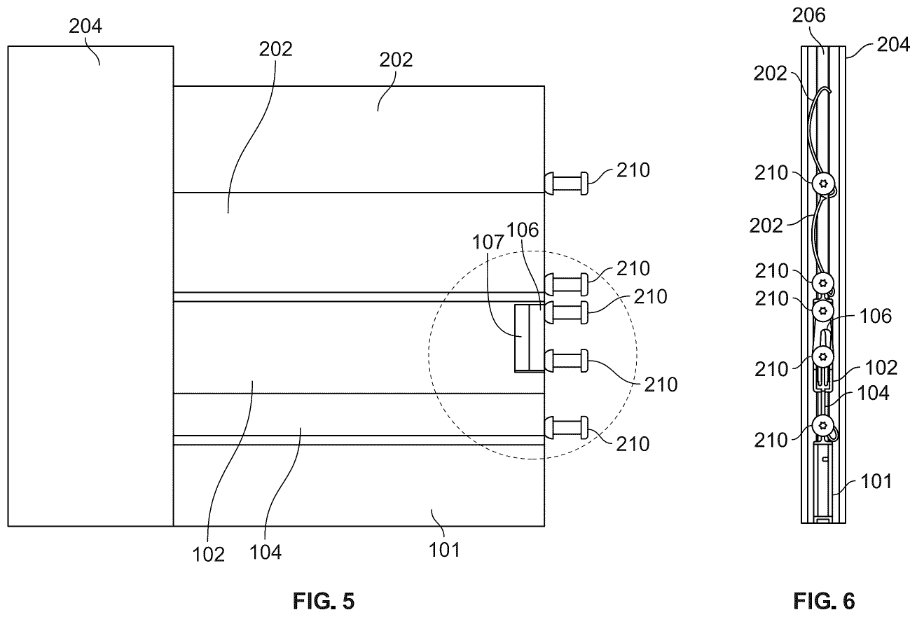

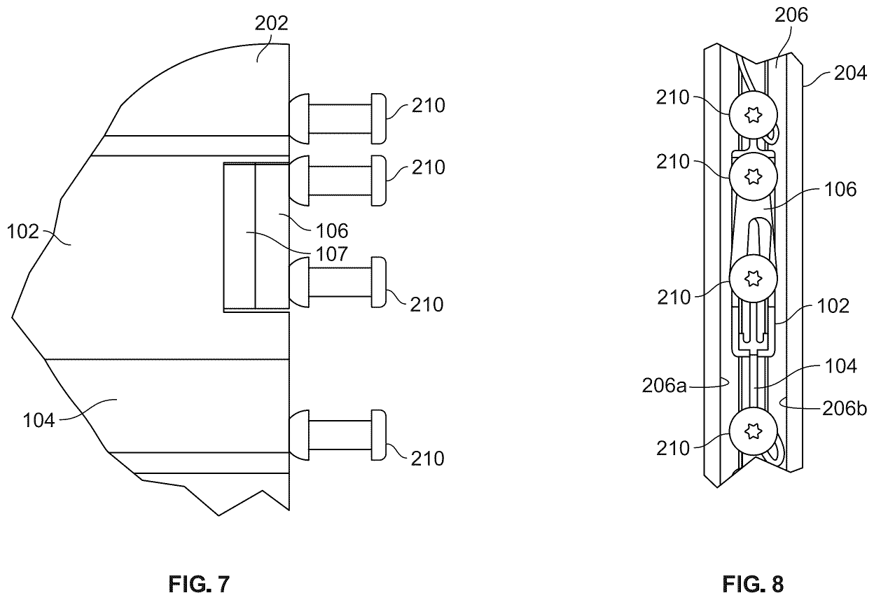

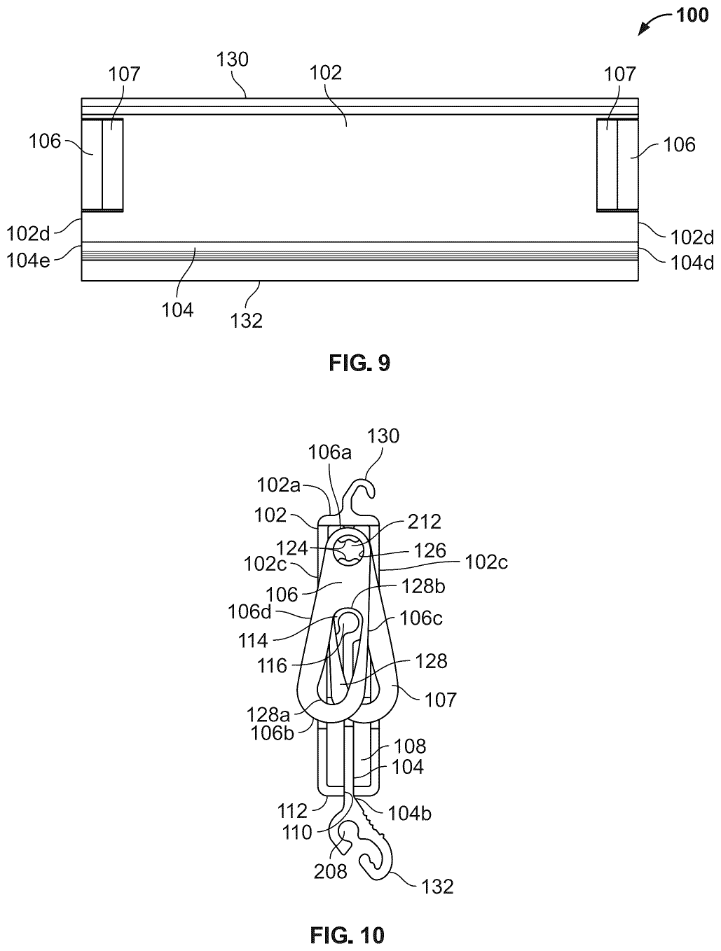

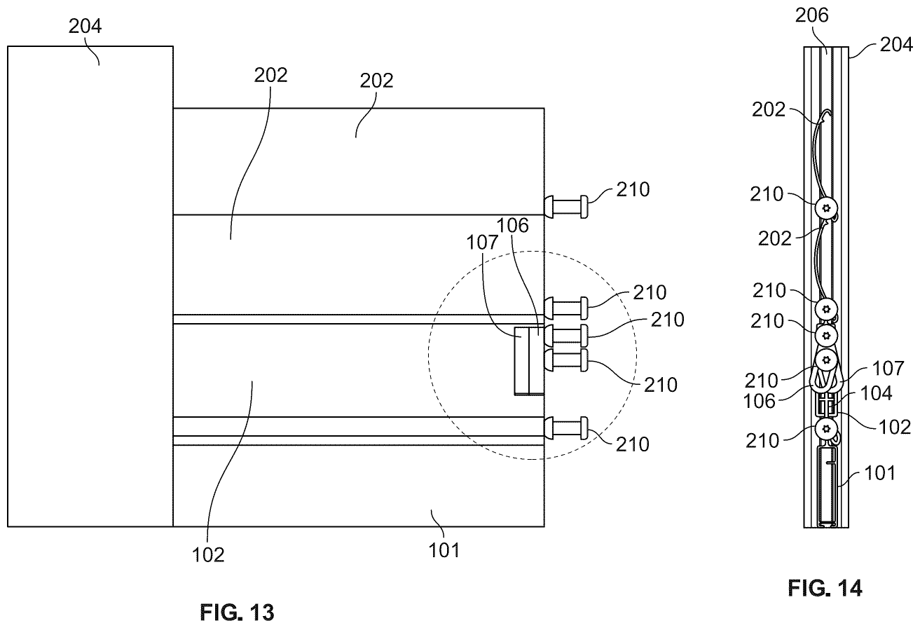

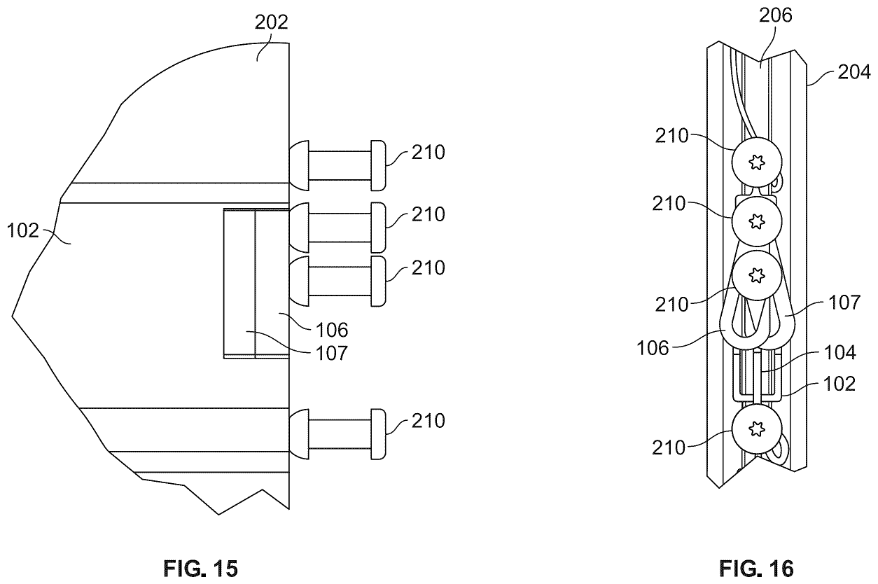

Referring to FIGS. 1-16, an embodiment of a lock slat 100 for a rolling shutter is shown. Lock slat 100 is intended to be incorporated in the series of linked slats that comprise the rolling shutter, and is preferably positioned at or near the end of the rolling shutter that contacts the bottom of the opening when the shutter is in the closed position. In one embodiment, lock slat 100 is positioned adjacent to a base slat 101.

Lock slat 100 comprises a housing 102, a cam slat 104, and a cam 106. Housing 102 has top and bottom edges 102a and 102b, opposite sides 102c, and opposite ends 102d. In one embodiment, edge 102a is positioned at the top of lock slat 100, closest to the spindle of the rolling shutter, and edge 102b is positioned toward the bottom of the lock slat, closest to the base slat or the bottom of the opening when the slat is in the closed position. A longitudinal channel 108 is formed between opposite sides 102c, with an opening 110 at edge 102b. In one embodiment, opening 110 has an internal lip 112, such that the width of the opening is smaller than the width of channel 108. Channel 108 and opening 110 are sized and shaped to receive cam slat 104, as described below.

Cam slat 104 has top and bottom edges 104a and 104b, opposite sides 104c, and opposite ends 104d and 104e. Edge 104a includes a receptacle 114 with an opening 116 that is sized and shaped to receive a cam pin 118. In one embodiment, receptacle 114 and opening 116 are positioned at cam slat end 104d and/or 104e. In a preferred embodiment, a receptacle 114 and an opening 116 are positioned at each end 104d and 104e.

Cam slat 104 is slidably received in channel 108 and opening 110, with edge 104a positioned within the channel. In one embodiment, edge 104b extends from or projects out of channel opening 110. Cam slat 104 is moveable within channel 108 transversely to housing 102, to telescopically increase or decrease the transverse height of lock slat 100 (arrow “A”) between a maximum and minimum height.

In one embodiment, cam slat 104 has a rib 120 that projects from one or both sides 104c. Rib 120 is sized and shaped to engage internal lip 112 of opening 110, and operates as a stop for the transverse movement of cam slat 104 away from channel 108, as best shown in FIG. 2. Rib 120 prevents cam slat 104 from being completely withdrawn or removed from channel 108 and housing 102, and limits the maximum height of lock slat 100. In a preferred embodiment, each side 104c of cam slat 104 has a longitudinal rib 120 that extends the length of the cam slat.

Cam slat 104 preferably moves along a plane transverse to channel 108, and is restricted from tilting or rocking within the channel. In one embodiment, rib 120 has a transverse flange 122 that extends parallel to the interior wall of channel 108, to increase the contact surface between rib 120 and the interior wall. Flange 122 guides and restricts the movement of cam slat 104 along a transverse plane within channel 108, and prevents the cam slat from tilting within the channel. Cam slat 104 may have other configurations that restrict the movement of the cam slat in channel 108. For example, cam slat 104 may have multiple, spaced apart ribs 120 formed on both sides 104c.

Cam 106 is positioned in housing 102, and is sized and shaped to fit substantially within the horizontal width of the housing between housing sides 102c. In one embodiment, cam 106 is coupled to housing 102 and is moveable between a locked position where at least a portion of cam 106 extends or projects beyond the horizontal width of housing 102, and an unlocked position where the cam 106 does not extend or project substantially beyond the horizontal width of the housing.

In a preferred embodiment, cam 106 is rotatably coupled to housing 102. In the embodiment shown in FIG. 2, housing 102 has a pivot 124 positioned in channel 108. Cam 106 has a length between top and bottom ends 106a and 106b, and a width between opposite inner and outer sides 106c and 106d. The width of cam 106 is about the horizontal width of housing 102 or less. Cam top end 106a has an opening 126 that is sized and shaped to receive pivot 124 and allow cam 106 to rotate within housing 102. Cam bottom end 106b is rotatable between a locked position where the bottom end extends or projects beyond the horizontal width of housing 102, and an unlocked position where the bottom end does not extend or project substantially beyond the horizontal width of the housing.

In one embodiment, cam 106 has a cam slot 128 that is sized and shaped to receive cam pin 118, and slidably couple cam 106 to cam slat 104. Cam slot 128 has a first end 128a proximal to cam bottom end 106b, and a second end 128b distal to the cam bottom end. Cam slot 128 is eccentrically shaped and extends at least partly across the width of cam 106. In one embodiment, cam slot 128 is curved or extends diagonally across cam 106, with first end 128a positioned centrally between cam outer sides 106c and 106d, and second end 128b positioned proximal to cam inner side 106c.

The sliding movement of cam 106 within housing channel 108 causes cam pin 118 to travel in cam slot 128, between ends 128a and 128b. Because the movement of cam slat 106 and cam pin 118 is restricted to a plane within housing channel 108, the travel of cam pin 118 along the eccentric shape of cam slot 128 causes cam 106 to rotate on pivot 124. As cam pin 118 moves toward cam slot end 128b, cam bottom end 106b rotates away from housing 102 and toward the locked position to extend beyond the horizontal width of the housing. As cam pin 118 moves toward cam slot end 128a, cam bottom end 106b rotates toward housing 102 and toward the unlocked position where the bottom end is withdrawn and does not project substantially beyond the horizontal width of the housing. In the embodiment shown in FIG. 2, cam 106 rotates clockwise toward the locked position and counter-clockwise toward the unlocked position.

Those of skill in the art will appreciate that cam slot 128 may have the opposite configuration, where cam slot 128 is curved or extends diagonally across cam 106, with first end 128a positioned centrally between cam outer sides 106c and 106d, and second end 128b positioned proximal to cam outer side 106d. This opposite configuration will cause cam 106 to rotate in the opposite direction between locked and unlocked positions.

In one embodiment, lock slat 100 comprises two cams 106 and 107 that are rotatably coupled to pivot 124, and are moveably coupled to cam slat 104 by cam pin 118. Cams 106 and 107 preferably move in opposite directions between the locked and unlocked positions—e.g., first and second cams having opposite configurations, where the first cam rotates in a clockwise direction and the second cam rotates in a counter-clockwise direction toward an unlocked position. In a further preferred embodiment, cams 106 and 107 are positioned adjacent to each other, and have mirror image configurations that rotate in opposite directions.

Lock slat 100 is incorporated in a rolling shutter system 200 comprising a series of slats 202. Each slat 202 has an upper edge with a hook-shaped engaging track, and a lower edge with a receiving track having a pocket for receiving the engaging track of another slat 202. Linking the engaging track of a first slat 202 in the receiving track of a second slat 202 forms an articulated hinge between the slats. An example of a conventional rolling shutter slat is described in U.S. Pat. No. 9,074,411 to Miller et al.

In one embodiment, lock slat 100 has an engaging track 130 formed at housing edge 102a and a receiving track 132 formed at cam slat edge 104b, to allow the lock slat to be incorporated into a series of rolling shutter slats. Lock slat 100 may be incorporated at one end of the series of slats, such that the lock slat is positioned close to the bottom of the opening when the shutter is in the closed position. In a preferred embodiment, lock slat receiving track 132 is coupled to the engaging track of base slat 101.

In one embodiment, rolling shutter system 200 further comprises an end retention system. Examples of conventional end retention systems are described in U.S. Pat. Nos. 8,616,261 and 8,925,617 to Miller. The rolling shutter is secured in the opening of a structure by a frame positioned at the perimeter of the opening. The frame comprises a guide track 204 along one side of the opening, which has a channel 206 that is sized and shaped to receive the ends of slats 202, to align and hold the slats in position to cover the opening.

A receptacle is formed at the ends of slats 202 for receiving an end retention device, such as a such as a fastener with a washer that is retained within the guide track channel 206. In one embodiment, lock slat receiving track 132 has a receptacle 208 for receiving an end retention device 210. In another embodiment, housing pivot 124 has a receptacle 212 for receiving an end retention device 210. In yet another embodiment, cam pin 118 may comprise an end retention device 210.

In one embodiment, cam 106 is positioned at an end 102d of housing 102. The insertion of the end of lock slat 100 into guide track channel 206, positions housing end 102d and cam 106 within the guide track channel. When cam 106 is moved to the locked position, the cam extends beyond the horizontal width of housing 102 and contacts or engages an inner wall 206a of guide track channel 206 to resist the movement of lock bar 100 and the rolling shutter (e.g., by friction). In a preferred embodiment, lock slat 100 comprises adjacent cams 106 and 107 that are positioned at housing end 102d, within guide track channel 206, and that rotate in opposite directions to engage the opposite inner walls 206a and 206b of guide track channel 206. More preferably, rolling shutter system comprises a guide track 204 at both sides of the opening of a structure, and lock slat 100 comprises adjacent cams 106 and 107 positioned at both ends 102d of housing 102.

FIGS. 1-8 show lock slat 100 in an unlocked position with cam slat 104 extended from housing 102 to the maximum height of the lock slat. In operation, as the rolling shutter is raised from the opening to an open position, cam slat 104 travels transversely (downward) out of housing channel 108 under the force of gravity, and lock slat 100 automatically extends telescopically to its maximum height and the unlocked position. As cam slat 104 moves downward out of housing 102, cam pin 118 moves toward cam slot end 128a and cams 106 and 107 rotate toward the housing. In the unlocked position, cam pin 118 is positioned at cam slot end 128a, and cams 106 and 107 do not extend or project substantially beyond the horizontal width of housing 102 and are withdrawn from engagement and do not contact opposite inner walls 206a and 206b of guide track channel 206, which allows lock bar 100 and the rolling shutter to move freely in channel 206 of guide track 204.

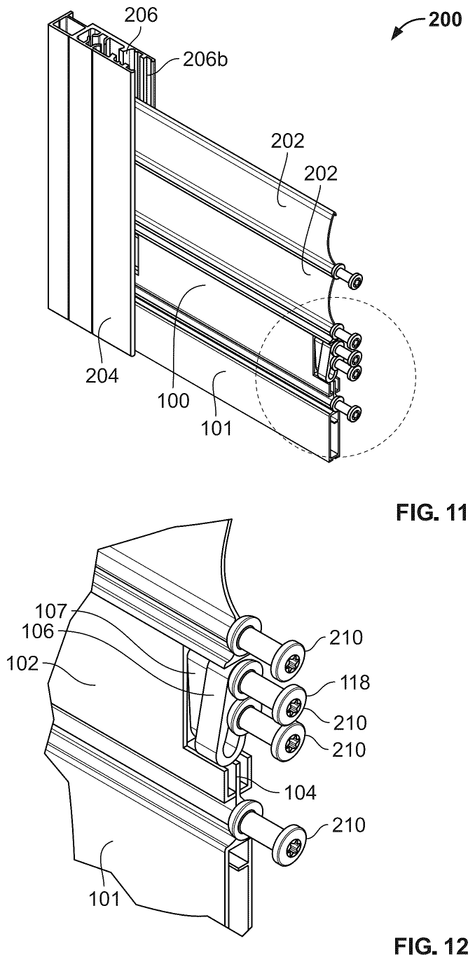

FIGS. 11-16 show lock slat 100 in the locked position with cam slat 104 retracted into housing 102 to the minimum height of the lock slat. As the rolling shutter is lowered to a closed position, contact with the bottom of the opening stops the movement of cam slat 104 while the slats 202 above and housing 102 continue to move downward. Cam slat 104 is forced to move transversely upward into housing channel 108, and lock slat 100 automatically retracts telescopically to its minimum height and the locked position. As cam slat 104 moves upward toward housing 102, cam pin 118 moves toward cam slot end 128b and cams 106 and 107 rotate away from the housing. In the locked position, cam pin is positioned at cam slot end 128b and cams 106 and 107 extend or project beyond the horizontal width of the housing to contact or engage the inner walls 206a and 206b of guide track channel 206 and resist the movement of lock slat 100 and the rolling shutter in channel 206 of guide track 204.

In the locked position, lock slat 100 advantageously resists attempts to improperly open rolling shutter—e.g., by attempting to pry or lever the bottom or base slat 101 of the rolling shutter upward. An upward force on the bottom or base slat 101 of the rolling shutter, forces cam slat 104 upward into channel 108 of housing 102, which reinforces the movement of cams 106 and 107 toward the locked position, and prevents the further upward movement of lock slat 100 and the rolling shutter.

Those of skill in the art will appreciate that alternative configurations of the housing, cam slat, and cam are possible. In lock slat 100, cam 106 is rotatably coupled to housing 102 by cam pivot 124. Although cam 106 rotates between the locked and unlocked positions, the cam does not move transversely relative to housing 102. Therefore, it is convenient to position cam 106 in housing 102, as previously described. For example, cam 106 (and cam 107) may be positioned in an opening or cut out portion of housing sides 102c to allow the cam to rotate beyond the horizontal width of the housing.

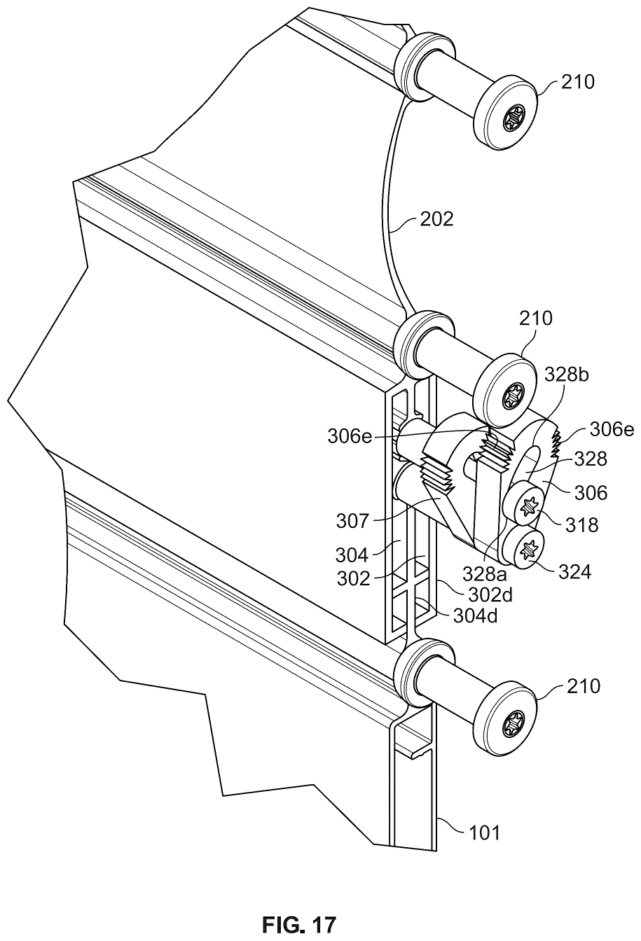

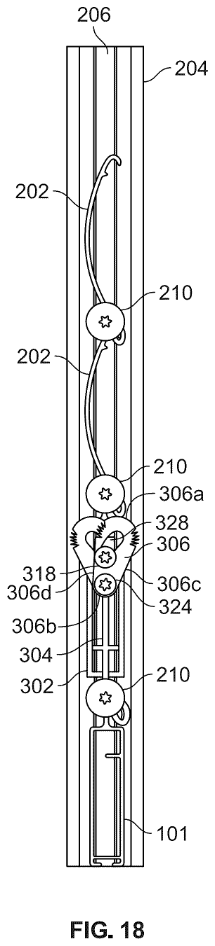

FIGS. 17 and 18 show an alternative embodiment of a lock slat 300 having a housing 302, cam slat 304 and cam 306 with a similar configuration to lock slat 100, except that cam 306 is vertically inverted or upside down. In contrast to lock slat 100, the movement of cam slat 304 in housing 302 causes cam 306 to move transversely to housing 302 as the cam rotates between the locked and unlocked positions.

Cam 306 has a similar configuration to cam 106, but has a bottom end 306b that is rotatably coupled to the cam slat 304 by a cam pivot 324, and a top end 306b that rotates between a locked position where the top end extends or projects beyond the horizontal width of housing 302, and an unlocked position where the top end does not extend or project substantially beyond the horizontal width of the housing. Like cam 106, cam 306 has an eccentrically shaped cam slot 328 that extends at least partly across the width of cam 306 (e.g., curved or extending diagonally across cam 306). Cam slot 328 has a first end 328a proximal to cam bottom end 306b (and to pivot 324), and a second end 328b distal to the cam bottom end. Cam slot 328 is curved with first end 328a positioned proximal to cam outer side 306d, and second end 328b positioned centrally between cam outer sides 306c and 306d.

Housing 302 has a cam pin 318 that is received in cam slot 328 to slidably couple cam 306 to the housing. Cam slot 328 is sized and shaped to receive cam pin 318, such that the movement of the cam slot on the cam pin causes cam 306 to rotate between the locked and unlocked positions. In operation, the transverse movement of cam slat 304 in housing channel 308 causes pivot 324 and cam 306 to move transversely to housing 302. The transverse movement of cam 306 is guided by the travel of cam slot 328 on cam pin 318, which causes the cam to rotate on pivot 324.

As the rolling shutter is raised from the opening to an open position, cam slat 304 travels transversely (downward) out of housing channel 308 under the force of gravity, and lock slat 300 automatically extends telescopically toward the unlocked position. The downward movement of cam slat 304 causes pivot 324 and cam 306 to move downward and away from housing 308. As cam 306 moves downward, the travel of cam slot 328 on cam pin 318 causes cam top end 306a to rotate (counterclockwise) toward the unlocked position. At maximum telescopic extension of lock slat 300, cam 306 is in the unlocked position with cam pin 318 positioned at cam slot end 328b, and cam top end 306a is withdrawn toward the lock slat and does not project substantially beyond the horizontal width of the housing.

As the rolling shutter is lowered to a closed position, contact with the bottom of the opening forces cam slat 304 transversely (upward) into housing channel 308, and lock slat 300 automatically retracts telescopically toward the locked position. The upward movement of cam slat 304 causes pivot 324 and cam 306 to move upward and toward housing 308. As cam 306 moves upward, the travel of cam slot 328 on cam pin 318 causes cam top end 306a to rotate (clockwise) toward the locked position. At minimum telescopic extension of lock slat 300, cam pin 318 is positioned at cam slot end 328a, and cam top end 306a is rotated away from the lock slat into the locked position (e.g., to engage the opposite inner walls 206a and 206b of guide track channel 206). Those of skill in the art will appreciate that cam slot 328 may have the opposite configuration—i.e. having a curve with end 328a positioned proximal to cam outer side 306c such that cam top end 306a rotates clockwise toward the locked position and counterclockwise toward the unlocked position, similarly to cam 106.

To accommodate the transverse movement of cam 306 relative to housing 302, the cam may be positioned outside of the housing. In one embodiment, housing and cam slat ends 302d and 304d (or 304e, not shown) are positioned at guide track 204, and cam pin 318 and pivot 324 extend from the housing and cam slat ends into channel 206 of guide track 204. For example, cam pin 318 and pivot 324 may each have first ends that are respectively coupled to the ends of housing 302 and cam slat 304, and opposite second ends positioned in guide track channel 206. Cam 306 is coupled to the second end of pivot 324, to position the cam in guide track channel 206. The second end of cam pin 318 is similarly positioned in cam slot 328.

In one embodiment, lock slat 300 may comprise cams 306 and 307 that are positioned adjacent to each other and have mirror image configurations that rotate in opposite directions, similarly to cams 106 and 107 of lock slat 100. The rolling shutter system preferably comprises a guide track 204 at both sides of the opening of a structure, and lock slat 300 comprises adjacent cams 306 and 307 positioned at both ends 102d of housing 102.

In another embodiment, the portion of cam top end 306a (or 106a) that contacts guide track channel inner walls 206a and 206b in the locked position may have a knurled or ridged surface 306e that increases friction and resistance to movement of the lock slat 300 in guide track channel 206.

While the disclosure has been described in terms of exemplary embodiments, those skilled in the art will recognize that the disclosure can be practiced with modifications in the spirit and scope of the instant disclosure. These examples given above are merely illustrative and are not meant to be an exhaustive list of all possible designs, embodiments, applications or modifications of the disclosure.

What is claimed is:

1. A lock slat for a rolling shutter, comprising:
a housing having opposite first and second sides, a housing channel formed between the first and second sides, and a housing width defined between the first and second sides;
a cam coupled to the housing, the cam moveable between a locked position where the cam projects beyond the housing width, and an unlocked position where the cam does not project beyond the housing width; and
a cam slat slidably received in the housing channel, the cam slat coupled to the cam;
wherein the movement of the cam slat in the housing channel moves the cam between the locked and unlocked positions.

2. The lock slat of claim 1, wherein the cam slat is movable telescopically in the housing channel between a maximum and a minimum lock slat height; and
wherein the cam is in the locked position at the minimum lock slat height, and is in the unlocked position at the maximum height.

3. The lock slat of claim 1, wherein the cam is rotatably coupled to the housing; and
wherein the movement of the cam slat in the channel rotates the cam between the locked and unlocked positions.

4. The lock slat of claim 1, further comprising a cam pin coupled to the cam slat;
wherein the cam includes a cam slot that is sized and shaped to slidably receive the cam pin; and
wherein the movement of the cam slat in the housing channel moves the cam pin in the cam slot, and the movement of the cam pin in the cam slot moves the cam between the locked and unlocked positions.

5. The lock slat of claim 4, wherein the cam is rotatably coupled to the housing; and
wherein the movement of the cam pin in the cam slot rotates the cam between the locked and unlocked positions.

6. The lock slat of claim 4, wherein the cam has opposite first and second cam sides, and the cam slot has opposite first and second slot ends, the first slot end positioned centrally between the first and second cam sides, and the second slot end positioned proximal to the second cam side; and
wherein the cam is in the unlocked position when the cam pin is positioned at the first slot end, and is in the locked position when the cam pin is at the second slot end.

7. The lock slat of claim 6, wherein lock slat is movable telescopically in the housing channel between a maximum and a minimum lock slat height; and
wherein the cam pin is positioned at the first slot end at the maximum lock slat height, and is positioned at the second slot end at the minimum lock slat height.

8. The lock slat of claim 1, wherein the cam is rotatably coupled to the cam slat; and
wherein the movement of the cam slat in the housing channel rotates the cam between the locked and unlocked positions.

9. The lock slat of claim 1, further comprising a cam pin coupled to the housing;
wherein the cam includes a cam slot that is sized and shaped to slidably receive the cam pin; and
wherein the movement of the cam slat in the housing channel moves the cam slot on the cam pin, and the movement of the cam slot on the cam pin rotates the cam between the locked and unlocked positions.

10. The lock slat of claim 9, wherein the cam has opposite first and second cam sides, and the cam slot has opposite first and second slot ends, the first slot end positioned centrally between the first and second cam sides, and the second slot end positioned proximal to the second cam side; and
wherein the cam is in the unlocked position when the cam pin is positioned at the first slot end, and is in the locked position when the cam pin is at the second slot end.

11. The lock slat of claim 10, wherein lock slat is movable telescopically in the housing channel between a maximum and a minimum lock slat height; and
wherein the cam pin is positioned at the first slot end at the maximum lock slat height, and is positioned at the second slot end at the minimum lock slat height.

12. A locking system for a rolling shutter, comprising:
a guide track including a guide channel;
a lock slat comprising:
a housing including a housing channel, and having an end positioned at the guide channel;
a cam slat slidably received in the housing channel; and
a first cam coupled to the housing and the cam slat, the first cam moveable between a locked position where the first cam engages the guide track, and an unlocked position where the first cam does not engage the guide track;
wherein the movement of the cam slat in the housing channel moves the cam between the locked and unlocked positions.

13. The locking system of claim 12, wherein the cam slat is movable telescopically in the housing channel between a maximum and a minimum lock slat height; and
wherein the cam is in the locked position at the minimum lock slat height, and is in the unlocked position at the maximum height.

14. The lock slat of claim 12, wherein the cam is rotatably coupled to the housing; and
wherein the movement of the cam slat in the channel rotates the cam between the locked and unlocked positions.

15. The lock slat of claim 12, wherein the cam is rotatably coupled to the cam slat; and
wherein the movement of the cam slat in the housing channel rotates the cam between the locked and unlocked positions.

16. The lock slat of claim 12, wherein the lock slat further comprises a second cam coupled to the housing and the cam slat, the second cam moveable between a locked position where the second cam engages the guide track, and an unlocked position where the second cam does not engage the guide track; and
wherein the first and second cams rotate in opposite directions between the locked and unlocked positions.

17. The locking system of claim 16, wherein the movement of the cam slat in the housing channel rotates the first and second cams in opposite directions between the unlocked and locked positions.

18. The locking system of claim 16, wherein the first and second cams are coupled to the end of the housing, are positioned in the guide channel adjacent to each other.

19. A rolling shutter system comprising:
a guide track including a guide channel;
a plurality of shutter slats, each shutter slat having an engaging track and a receiving track, the receiving track having a pocket for receiving the engaging track of another shutter slat;
a lock slat comprising:
a housing including a housing channel, the housing having an end positioned at the guide channel, and an edge having an engaging track received in a receiving track of a shutter slat;
a cam coupled to the housing, the cam moveable between a locked position wherein the cam engages the guide track, and an unlocked position wherein the cam does not engage the guide track;
a cam slat slidably received in the housing channel, the cam slat coupled to the cam; and
wherein the movement of the cam slat in the housing channel moves the cam between the unlocked and locked positions.

20. The rolling shutter system of claim 19, further comprising a base slat having an engaging track;
wherein the cam slat has a receiving track, and wherein the base slat engaging track is received in the cam slat receiving track.
